(19) United States
(12) Patent Application Publication
(10) Pub. No.: US 2025/0337694 A1
(43) Pub. Date: Oct. 30, 2025

(54) ROUTING AND SCHEDULING METHOD BASED ON MULTI-CYCLE CSQF MECHANISM AND GDRL

(71) Applicant: Zhejiang Sci-Tech University, Hangzhou (CN)

(72) Inventors: Weiqiang XU, Hangzhou (CN); Yelin HUANG, Hangzhou (CN)

(73) Assignee: Zhejiang Sci-Tech University, Hangzhou (CN)

(21) Appl. No.: 18/923,649

(22) Filed: Oct. 22, 2024

Related U.S. Application Data
(63) Continuation of application No. PCT/CN2024/099095, filed on Jun. 14, 2024.

(30) Foreign Application Priority Data
Apr. 25, 2024 (CN) 202410503980.0

(51) Int. Cl. H04L 47/62

(52) U.S. Cl. CPC H04L 47/62

(57) ABSTRACT

A routing and scheduling method based on multi-cycle CSQF mechanism and GDRL is provided. The routing and scheduling method includes the following steps: S1, initializing a cycle index detection mechanism, a queue mapping and a queue mapping constraint of a multi-cycle CSQF; S2, constructing a DFRLLS model; S3, optimizing the DFRLLS model based on GDRL; S4, off-line training a learning strategy of a GDRL model; S5, making a decision on-line based on a trained GDRL model. The routing and scheduling method based on multi-cycle CSQF mechanism and GDRL is adopted, and GCN network is used to extract topology information between networks. Compared with the method of only using reinforcement learning, the routing and scheduling method can achieve more flow scheduling, and its performance is also stable under complex network topology, multi-cycle CSQF can reduce the start-to-end delay of the flow compared to the CSQF.

### CROSS REFERENCE TO THE RELATED APPLICATIONS

This application is a continuation application of International Application No. PCT/CN2024/099095, filed on Jun. 14, 2024, which is based upon and claims priority to Chinese Patent Application No. 202410503980.0, filed on Apr. 25, 2024, the entire contents of which are incorporated herein by reference.

### TECHNICAL FIELD

The present invention relates to the technical field of routing and scheduling, and in particular to a routing and scheduling method based on multi-cycle cycle specified queuing and forwarding (CSQF) mechanism and graph deep reinforcement learning (GDRL).

### BACKGROUND

Cyclic Queuing and Forwarding (CQF) is proposed as a peristaltic shaper, which circularly and alternately opens and closes two queues on the port. It divides the time into cycles T with the same length, the data packets sent by the previous node in cycle C must be received by the subsequent nodes in the same cycle, and then sent out in the C+1 cycle. Although CQF can well control the delay of each hop (at most two cycles), the scalability of this mechanism is not strong, only suitable for small networks, and it requires complete synchronization between nodes.

In order to improve flexibility and scalability, the CSQF mechanism is devised as an emerging standard draft of the IETF DN working group as an evolution of the CQF mechanism. The CSQF mechanism proposes to use more queues to delay data packets and specify the corresponding cycle to transmit data packets. Within the router that supports the CSQF mechanism, each output port will be equipped with N queues, in N queues, N_{D}(N_{D}≤N) queues are reserved for time-critical flow, and the remaining non-critical (N_{C}) queues are used for best effort (BE) flow. The N queues transmit data packets in a circular manner, that is, in each cycle, only one queue is active, which is used to send data packets to the physical link, and the other (N−1) inactive queues are closed and the data packets are queued for future transmission, it should be noted that the number of packets queued in each inactive queue is related to the buffer size of each queue, improper enqueuing can lead to packet loss. N_{D} time-sensitive queues are dedicated to time-critical flows through resource reservation. Assigning packets to a specific queue actually determines their transmission cycle, and packets can be delayed by up to (N−1) cycles.

Most of the existing researches on deterministic network-based cycle specified queuing and forwarding (CSQF) study routing and scheduling at a single-link rate, that is, the cycle length of each node is the same. In the actual industrial scene, multi-link rate is also more common, in a network composed of multi-link rate, in order to be compatible with low-speed links, it is necessary to set the high-speed link cycle to be the same as the low-speed link, resulting in waste of resources in high-speed links, and the delay from the starting point of the flow to the ending point is also extremely high.

Meanwhile, the existing methods generally solve the routing problem of deterministic networks (DN) through deep reinforcement learning, but this method cannot fully utilize the topology information between networks for fusion feature extraction (the main reason is that the topology information is irregular graph structure information, and the fully connected neural network used in deep reinforcement learning is used for Euclidean data).

### SUMMARY

In order to solve the above problems, the present invention provides a routing and scheduling method based on multi-cycle CSQF mechanism and GDRL, which uses a graph convolutional network (GCN) network to extract topology information between networks, compared with the method of only using reinforcement learning, it can achieve more flow scheduling, and its performance is also stable under complex network topology, while multi-cycle CSQF can reduce the start-to-end delay of the flow.

In order to achieve the above-mentioned objective, the present invention provides a routing and scheduling method based on multi-cycle CSQF mechanism and GDRL, comprising the following steps:
S1, initializing a cycle index detection mechanism, a queue mapping and a queue mapping constraint of a multi-cycle CSQF;
S2, constructing a deterministic flow routing and a low-latency scheduling (DFRLLS) model;
S3, optimizing the DFRLLS model based on GDRL;
S4, off-line training a learning strategy of a GDRL model;
S5, making a decision on-line based on a trained GDRL model.

The present invention has the following advantageous effects:
1, using a GCN network to extract topology information between networks, compared with the method of only using reinforcement learning, it can achieve more flow scheduling, and its performance is also stable under complex network topology.
2, using the multi-cycle CSQF mechanism can achieve a lower start-to-end delay of the flow in a multi-link rate network compared to the same cycle CSQF.

Further detailed descriptions of the technical scheme of the present invention can be found in the accompanying drawings and embodiments.

### BRIEF DESCRIPTION OF THE DRAWINGS

FIG. 1 is a frame diagram of the GDRL of a routing and scheduling method based on the multi-cycle CSQF mechanism and GDRL of the present invention;

FIGS. 2A-2D are four queue mapping graphs of a routing and scheduling method based on the multi-cycle CSQF mechanism and GDRL of the present invention; wherein FIG. 2A is a mapping from a high-speed port to a high-speed port; FIG. 2B is a mapping from a high-speed port to a low-speed port; FIG. 2C is a mapping from a low-speed port to a low-speed port; FIG. 2D is a mapping from a low-speed port to a high-speed port;

FIG. 3 is a link transmission diagram of the CSQF network running in the same cycle;

FIG. 4 is a comparison result diagram of a deterministic flow scheduling quantity in a simulation experiment of the present invention;

FIGS. 5A-5C are comparison result diagrams of a start-to-end delay of a flow under the three topologies in a simulation experiment of the present invention; wherein FIG. 5A is a random topology structure; FIG. 5B is a ladder topology structure; FIG. 5C is a AFDX topology structure.

### DETAILED DESCRIPTION OF THE EMBODIMENTS

In order to make the objective, technical solution, and advantages of the present invention clearer and more specific, the present invention will be further described in detail below with reference to accompanying drawings and embodiments. It should be understood that the specific embodiments described herein are merely illustrative of the present invention and are not intended to limit the embodiments of the present invention. Based on the embodiments in the present application, all the other embodiments obtained by a person of ordinary skill in the art without involving any inventive effort fall within the scope of protection of the present application. Examples of the embodiments are shown in the drawings, wherein like or similar reference numerals refer to the same or similar elements or elements having the same or similar function throughout.

It should be noted that the terms “comprises” and “having”, and any variations thereof, are intended to cover a non-exclusive inclusion, such that a process, method, system, article, or server that comprises a list of steps or elements is not necessarily limited to those steps or elements expressly listed, but may comprise other steps or elements not expressly listed or inherent to such process, method, article, or device.

Like numbers and letters refer to like items in the following figures, and thus, once an item is defined in one figure, it need not be further defined and explained in the following figures.

In order to make full use of the topology information between networks, the present invention introduces a graph neural network. The topology information between networks is extracted by graph neural network and fused into deep reinforcement learning for routing allocation. In addition, in order to solve the problem of low utilization of high-speed link resources in multi-link rate networks, this patent proposes a multi-cycle CSQF mechanism, which reduces the start-to-end delay of the flow by setting the cycle of the adaptive link rate, and extends to general scenarios. On this basis, the scheduling constraints of multi-cycle CSQF are proposed.

Specifically, the following is discussed:

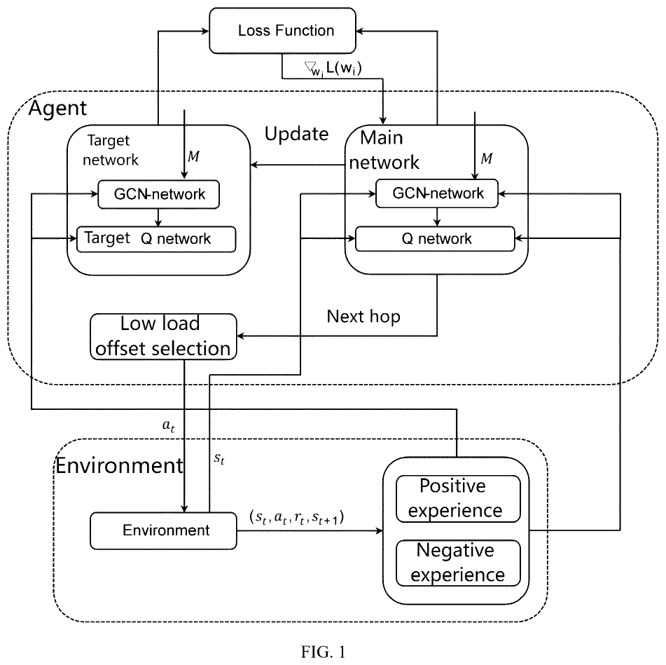

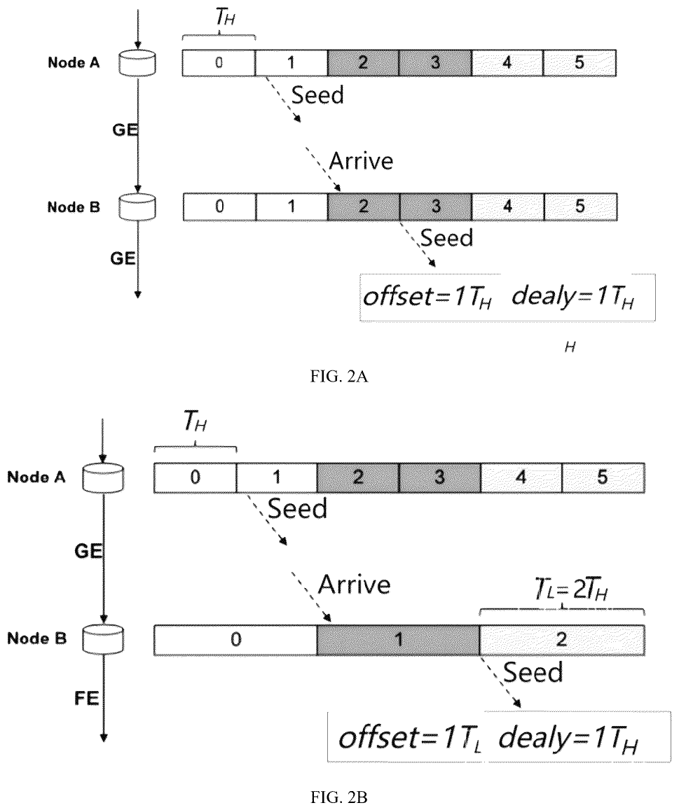

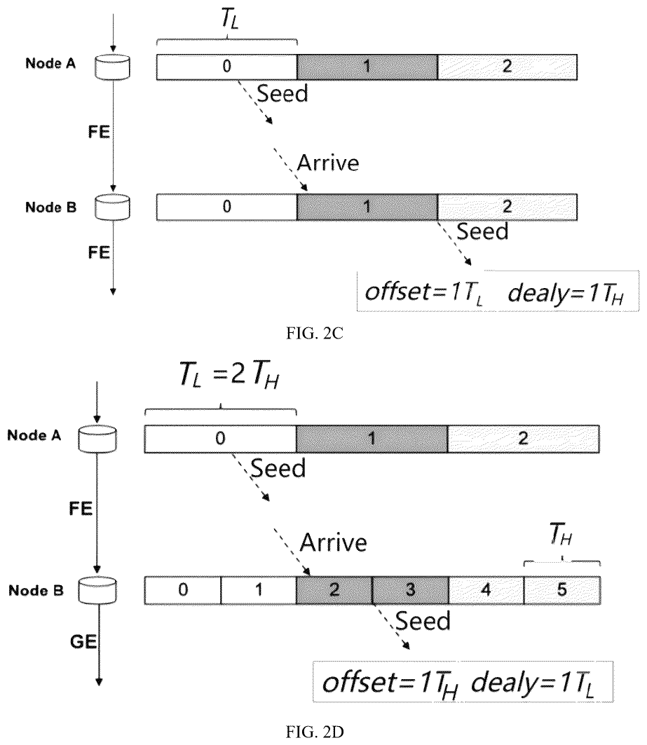

As shown in FIG. 1, a routing and scheduling method based on multi-cycle CSQF mechanism and GDRL comprises the following steps:
S1, a cycle index detection mechanism, a queue mapping and a queue mapping constraint of a multi-cycle CSQF are initialized;
in step S1, in the cycle index detection mechanism described, a length of a detection cycle is set to 6T_{H}, T_{H} is a detection short cycle, and the short cycle T_{H} and a long cycle T_{L} are detected at the same time, and the short cycle T_{H} is used as a detection granularity, and an output cycle index T_{id} is output;
in step S1, in the queue mapping, the output cycle index T_{id} is mapped to an exit queue Q_{id}, and when a ratio of the long cycle T_{L} to the short cycle T_{H} is R=2, the queue mapping is divided into the following four scenarios as shown in FIGS. 2A-2D:
a mapping from a high-speed port to a high-speed port: according to the output cycle index T_{id} of the flow received by the node and an offset is offset of the flow at the current node, the flow enters a sending queue, and a mapping relationship is expressed as:

$${Q}_{id} = ( {T}_{id} + offset ) mod 3 R$$

a mapping from a high-speed port to a low-speed port: for the flow arriving in the i^{th} cycle T_{L}, since the cycle detection is based on the short cycle T_{H} as the detection granularity, it needs to be converted in the long cycle queue, and a mapping relationship is expressed as:

$${Q}_{id} = ( ⌊ \frac{{T}_{id}}{R} ⌋ + offset ) mod 3$$

a mapping from a low-speed port to a low-speed port: due to the detection granularity is T_{H}, it is the same as the mapping from a high-speed port to a low-speed port, and a mapping relationship is expressed as:

$${Q}_{id} = ( ⌊ \frac{{T}_{id}}{R} ⌋ + offset ) mod 3$$

a mapping from a low-speed port to a high-speed port: the same as the mapping from the high-speed port to the high-speed port, and a mapping relationship is expressed as:

$${Q}_{id} = ( {T}_{id} + offset ) mod 3 R$$

in step S1, in the queue mapping constraint, mapping rules are divided into two types according to a cycle size of a source port and a destination port: the mapping from the high-speed port to the low-speed port and the mapping from the low-speed port to the high-speed port, a ratio of the source port cycle to the destination port cycle is denoted by

$${R}_{src , dest} = \frac{{T}_{src}}{{T}_{dest}} ;$$

when the flow is forwarded from the high-speed port to the low-speed port, that is, from the short cycle to the long cycle direction, comprising the equal cycle case, a mapping rule is as follows:

$$if {R}_{src , dest} \leq 1 : {Q}_{id} = ( ⌊ \frac{{T}_{id}}{{R}_{dest , H}} ⌋ + offset ) mod {Q}_{dest}$$

where, R_{dest,H} is a ratio of the cycle of the destination port to a shortest cycle; Q_{dest} is a number of queues of the destination port; offsetϵ[1, Q_{dest}−1];
when the flow is forwarded from the low-speed port to the high-speed port, that is, from the long cycle to the short cycle direction, comprising the equal cycle case, a mapping rule is as follows:

$$if {R}_{src , dest} \geq 1 {Q}_{id} = ( ⌊ \frac{{T}_{id}}{{R}_{src , H}} ⌋ + offset ) mod {Q}_{dest} offset ∈ [ 1 , {Q}_{dest} - 1 ]$$

where, R_{src,H} is a ratio of the cycle of the source port to the shortest cycle, Q_{dest} is the number of queues of the destination port; offsetϵ[1, Q_{dest}−1];

In step S1, the multi-cycle CSQF is extended under the following conditions:
if a switch supports m different CSQF cycles T₁, T₂, . . . , Tₘ, the shortest cycle Tₘᵢₙ=T₁, T₂, . . . , Tₘ, a longest cycle Tₘₐₓ=max(T₁, T₂, . . . , Tₘ), while satisfying that a ratio

$${R}_{i , j} = \frac{{T}_{i}}{{T}_{j}}$$

between any two cycles is an integer;

for the multi-cycle CSQF routers that meet the extension conditions, the shortest cycle Tₘᵢₙ is the detection granularity, the detection cycle is 3Tₘₐₓ, and the output T_{id} range of the packet arrival in the detection cycle is within [0,3R_{max,min}−1].

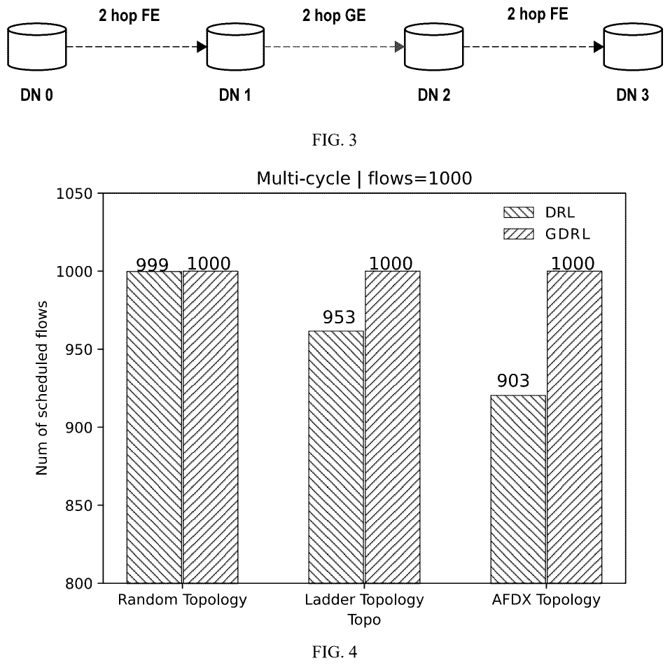

In the embodiment, as shown in FIG. 3, in the CSQF network running in the same cycle, in order to be compatible with low-speed links, the cycle is set to T=500 us, and the start-to-end delay of the flow is 8×500 us=4000 us, on the contrary, if the CSQF of different cycles is running on GE and FE, T_{GE}=250 us, T_{FE}=500 us, the delay of the multi-cycle CSQF is only 2×500+4×250+2×500=3000 us, therefore, the multi-cycle CSQF scheme can make better use of the high-speed link rate in multi-link rate networks. In addition, it is a reasonable multi-cycle strategy to match the link rate with the appropriate CSQF cycle, that is, to use short cycles on high-speed links and long cycles on low-speed links. It can reduce the start-to-end delay of a deterministic flow.
S2, a DFRLLS model is constructed (a deterministic flow routing and a low-latency scheduling model);
step S2 specifically comprises the following steps:
S21. a network flow model is constructed:
a network topology is abstracted as a directed graph, and the network topology is denoted as G and G={V, E}, where V is a set of DN routing nodes, E is a set of r edges connecting two network nodes (E ⊂V×V), and a full-duplex physical link between node Vₐ ϵV and node V_{b} ϵV contains two directed edges, and the two directed edges are denoted as [Vₐ, V_{b}]ϵE and [V_{b}, Vₐ]ϵE, respectively, a attribute of each link eᵢ=[Vₐ, V_{b}] is denoted by a quadruple:

$$< {e}_{i} \cdot S , {e}_{i} \cdot T , {e}_{i} \cdot C , {e}_{i} \cdot D >$$

where, eᵢ.S is a link rate; eᵢ.T is a cycle of multi-cycle CSQF on the link; eᵢ.C is a valid time slot capacity; eᵢ.D is a delay of the link, which comprises a propagation delay, a transmission delay and a processing delay;
S22, a DFRLLS model is constructed:
S221, for a flow fₖ to be scheduled, a controller determines that a link sequence of an only feasible scheduling link P is (e₁, e₂, . . . , eₘ), where a link eᵢ starts from the source node srcₖ, a link eₘ ends at the destination node dstₖ, and eᵢ and eᵢ₊₁ are adjacent links, and the following constraints are adopted:

$${e}_{1} \cdot src = {src}_{k} \\ {e}_{n} \cdot dst = {dst}_{k} \\ {e}_{i} \cdot dst = {e}_{i + 1} \cdot src$$

where e₁.src denotes a starting point of link e₁; srcₖ denotes a starting point of the flow; eₙ.dst denotes an ending point of link eₙ; dstₖ denotes a destination node; eᵢ.dst denotes an ending point of link eᵢ; eᵢ₊ₜ.src denotes a starting point of link eᵢ₊₁;
S222, an integer variable o_{k,e}_{ᵢ} is defined to denote an offset of all packets of the flow fₖ in each link eᵢ;
based on the different cycle lengths of different links, it is assumed that a first packet of the flow fₖ arrives at the source node srcₖ at

$${t}_{1}^{k} ,$$

which denotes that it is emitted from the source node srcₖ in the cycle tᵢ+o_{k,e}_{ᵢ}×eᵢ.T, and arrives the next node in the cycle t₁+o_{k,e}_{ᵢ}×eᵢ.T+eᵢ.D, which is denoted by

$${t}_{2}^{k} ,$$

so that the cycle of the flow fₖ is denoted by an integer sequence

$$( {t}_{1}^{k} , {t}_{2}^{k} , … , {t}_{n}^{k} ) , where {t}_{n}^{k} ∈ {Z}^{+}$$

is a cyclic index of the first packet arriving at the corresponding node eᵢ.src, and then the arrival cycle of remaining packets is calculated by

$${t}_{1}^{k} + l \times {period}_{k} l ∈ \{ 0 , 1 , … , n \} ;$$

S223, a scheduling Sₖ of the flow fₖ from the source node srcₖ to the destination node dstₖ is expressed as

$$\{ ( {e}_{1}^{k} , {t}_{1}^{k} , {o}_{k , {e}_{1}} ) , ( {e}_{2}^{k} , {t}_{2}^{k} , {o}_{k , {e}_{2}} ) , … , ( {e}_{n}^{k} , {t}_{n}^{k} , {o}_{k , {e}_{n}} ) \} ;$$

S224, whether Sₖ is valid for flow fₖ is judged by using the following conditions:
start-to-end delay constraint of the flow: the start-to-end delay of all packets of the flow fₖ does not allow to exceed the start-to-end delay limit delayₖ of the maximum flow:

$${t}_{n}^{k} - {t}_{1}^{k} \leq {delay}_{k}$$

cycle capacity constraint: if a packet of the flow fₖ is determined to be transmitted at link eᵢ of cycle t, denoted as

$$χ {k , {e}_{i}}_{t}^{} ,$$

the queue capacity of the cycle is shared among the scheduled flows, so a traffic load of any edge Ei within cycle t is within the upper limit of its queue capacity:

$${\sum }_{{f}_{k} ∈ F} {χ}_{k , {e}_{i}}^{t} \times {size}_{k} \leq {e}_{i} \cdot C$$

where F denotes a set of all flows fₖ; eᵢ.C denotes a capacity of the link eᵢ in a cycle t;
S225, the flow scheduling problem is expressed as: in the case of a given network topology and DN flow, find a valid scheduling for all flows, so that all time-triggered (TT) flows are scheduled, and the definition is as follows:

$$max {\sum }_{1}^{n} Scheduled ( {f}_{i} )$$

where n denotes a total number of scheduled flows; Scheduled(fᵢ) denotes a processing function of the flow, when the flow is scheduled successfully, it is Scheduled(fᵢ)=1, otherwise it is 0.

In step S225, the DN flow is defined as a periodic unicast flow from the source node to the destination node, a set of DN flows is denoted as [symbol] , and the DN flow fₖϵ [symbol] is defined as a tuple (srcₖ, dstₖ, periodₖ, delayₖ, sizeₖ), where srcₖ and dstₖ denote the source node and destination node of the flow fₖ, respectively; periodₖ denotes the period of the flow fₖ, that is, the data packet sent by the source node in each periodₖ cycle; sizeₖ denotes a size of the flow fₖ; delayₖ denotes a delay composition from the the start-to-end of the maximum flow;
since the flow has different periods periodₖ, a total scheduling cycle is defined, which is called a hypercycle, in each hypercycle, all network behaviors are the same, and the hypercycle periodₛ of all flows are calculated as the least common multiple of all flow periods.
S3, the DFRLLS model is optimized based on GDRL;
in step S3, the construction of the DFRLLS model reinforcement learning model is modeled, and the MDP (Markov decision process) model is constructed, the MDP model comprises state space [symbol] , action space [symbol] and reward space [symbol] ;
wherein, the state space [symbol] design is as follows: a system state sₜ is set to denote all the link information of the entire network, the deep reinforcement learning (DRL) agent is utilized to observe and use the system state sₜ to generate a schedule Sₖ for a flow fₖ, and then extract the network characteristics from the following three aspects to denote the system state sₜ: topology information, flow information and network cycle load information;
in the embodiment, sₜ can be divided into sₜ={s_{t,e}_{₂}, s_{t,e}_{₂}, . . . , s_{t,e}_{ᵢ}, eᵢϵE}, and each s_{t,e}_{ᵢ} consists of the following seven parts:
1) if the edge eᵢ is adjacent to an edge of a previous action or an edge of the source node srcₖ;
2) the distance from this edge to the destination node dstₖ;
3) whether this edge and the edge of the previous action form a loop, and the scheduling of the TT flow should avoid the occurrence of a network link loop, waste network resources and lead to a longer delay;
4) the congestion degree of an available offset cycle refers to a congestion condition of an available queue of a source node of the current edge eᵢ; in CSQF scheduling, the available offset period of a node depends on the number of queues thereof, and the congestion degree of the available offset period is the average load value of optional queues;
5) the congestion degree on this edge, a ratio of all available periods to the total period within a hypercycle;
6) a difference between the currently selected cycle and the stream delay boundary;
7) cyclic loading values (in percent).

A reachability matrix M of |E|×|E| is designed, where |E| is a number of edges in the whole network topology; the reachability matrix indicates whether a path exists between the link eᵢ and the link eⱼ, wherein one node is comprised;
sₜ are recalculated before each action decision is made, while M is calculated only once. sₜ denotes the information of each edge, M is related to the network topology.

The action space [symbol] is designed as follows: GDRL divides the path of TT flow into a set of adjacent edges, when DRL is used to solve the scheduling problem, the action space is large due to the large number of routing selections and frame transmission time points on the network nodes. GDRL reduces the size of the operation space by dividing the path of the TT flow into a set of adjacent edges. Each action determines only one edge, not the entire route. That is, the scheduling of TT flow

$${S}_{k} = \{ {a}_{1}^{k} , {a}_{2}^{k} , … , {a}_{n}^{k} \} = \{ ( {e}_{1}^{k} , {t}_{1}^{k} , {o}_{k , {e}_{1}} ) , ( {e}_{2}^{k} , {t}_{2}^{k} , {o}_{k , {e}_{2}} ) , … , ( {e}_{n}^{k} , {t}_{n}^{k} , {o}_{k , {e}_{n}} ) \} ,$$

scheduling Sₖ consists of a series of sub-actions

$${a}_{1}^{k} , {a}_{2}^{k} , … , {a}_{n}^{k} ,$$

a sub-action

$${a}_{i}^{k}$$

is defined by the tuple

$$( {e}_{i}^{k} , {t}_{i}^{k} , {o}_{k , {e}_{i}} ) , {e}_{i}^{k}$$

denotes an edge that the flow needs to pass through,

$${t}_{i}^{k}$$

denotes a time that the flow arrives the source node of link eᵢ, o_{k,e}_{ᵢ} denotes an offset of the flow fₖ in the source node of edge

$${e}_{i} , {t}_{i}^{k} + {o}_{k , {e}_{i}}$$

is a time that the flow is sent out from the source node of edge eᵢ; in this embodiment, a valid flow scheduling Sₖ needs to satisfy the constraint formula, end delay constraint and cycle capacity constraint in the sub-action.

Reward space [symbol] : when making an action decision aₜ, the reward space [symbol] is calculated by the Environment of the GDRL model, and the DRL model and GCN network of the GDRL model are trained with the reward space [symbol] to update its parameters θ; and through the following formula to determine whether the flow fₖ is successfully scheduled:

$${H}_{k} = \{ \begin{matrix}1 , & if the flow {f}_{k} is scheduled successfully \\ - 1 , & if the flow {f}_{k} is scheduled unsuccessfully\end{matrix}$$

moreover, the scheduling of each flow is composed of a series of sub-actions

$${a}_{i}^{k} = ( {e}_{i}^{k} , {t}_{i}^{k} , {o}_{k , {e}_{i}} ) ,$$

and the reward space [symbol] of the whole sub-actions is composed of two parts: a first part is the degree value corresponding to the offset of the flow fₖ on the link eᵢ, where the offset is determined by an offset allocation method, in the offset allocation method, the degree value is given for the offset cycle of the node, the higher the degree value, the lower the load in the offset cycle, and meanwhile the reward of the sub-action is given by the degree value; the rewards

$$R ( {a}_{i}^{k} )$$

for the first part sub-action are as follows:

$$R ( {a}_{i}^{k} ) = ρ ( {e}_{i} , {o}_{k , {e}_{i}} )$$

where, ρ(eᵢ, o_{k,e}_{ᵢ}) denotes an availability of the flow fᵢ in the link eᵢ source node offset o_{k,e}_{ᵢ} cycle;
a second part takes effect when the sub-action is part of the complete scheduling of the flow fₖ or not, that is, the reward for successful scheduling of the flow will only take effect when the sub-action

$${a}_{i}^{k}$$

is the last edge of the valid scheduling, after selecting a last action

$${a}_{n}^{k}$$

of the valid route, check whether the flow is scheduled successfully, and then add additional rewards to the second part in an attenuated manner to update the sub-action

$$R ( {a}_{1}^{k} ) , R ( {a}_{2}^{k} ) , … , R ( {a}_{n}^{k} ) ;$$

the reward

$$\hat{R} ( {a}_{i}^{k} )$$

for the second part sub-action is as follows:

$$\hat{R} ( {a}_{i}^{k} ) = R ( {a}_{i}^{k} ) + α {H}_{k} \times \frac{i}{n} ∀ i ∈ \{ 1 , … , n \}$$

where α denotes an attenuation factor, in this embodiment α is set to 0.5.
Step S3 specifically comprises the following steps:
S31, an optimization objective is set to maximize the number of scheduled flows under a given number of flows, and obtain the optimal DFRLLS scheduling strategy:

$${max}_{π} 𝔼 [ {Σ}_{{f}_{k} ∈ ℱ} {Σ}_{i = 1}^{n} {β}^{i} R ( {a}_{i}^{k} ) ]$$

where π* denotes to maximize the long-term return of the flows mapped to the network;

$$R ( {a}_{i}^{k} )$$

denotes a reshaping reward under strategy π; a discount factor β denotes a ratio of the current reward to the subsequent reward, the discount factor β is an adjustable parameter similar to the attenuation factor, which may vary in different task scenarios, but the value range is between (0,1); in this embodiment, it is set to 0.5;
S32. an edge selection is carried out based on the GDRL network model, and an optimization problem of the DFRLLS model is transformed into an optimization problem of maximizing the expected future discounted returns:
the GCN (graph convolutional network) is used to extract a spatial dependence of the network topology, and the extracted features are fused with the link features, the extracted features are input into the main network and the Q value is output.
Step S32 specifically comprises the following steps:
S321, a three-layer GCN network is used as a feature extractor to extract a spatial correlation of the network topology:
Environment inputs a link state sₜ and the reachability matrix M into the main network, the main network uses the GCN network to process each link by aggregating the features of its adjacent links, the aggregated features and the original link state sₜ are input into a function approximator together to generate the next hop for each flow, and an offset is assigned to this hop;
in step S321, the offset is selected based on the number of receiving node queues:
in MCCSQF, the cycle of nodes is different, the number of queues for TT flow scheduling is different, and the range of offset selection is different, therefore, in the selection of offset, this embodiment uses a selection method based on the number of queues of receiving nodes. Specifically, an appropriate offset oₑ_{ᵢ} will enable the edge eᵢ to carry more TT flows. When the flow arrives at a corresponding port of the node, if the load of the queue is not considered, only the fast forwarding is guaranteed, it is easy to map to the next queue to be sent, resulting in a corresponding cycle load of the queue is too high, and more flows cannot be scheduled. The offset allocation method fully considers the load of the receiving queue. A low-load queue is selected for scheduling. The main idea is to make a difference between the load of each receiving queue and the average load of all receiving queues, and consider an average load sent by the flow in a hypercycle.

The difference between the load of each receiving queue and the average load of all receiving queues is made, and the average load sent by the flow in a hypercycle is considered, and ρ(eᵢ, o_{k,e}_{ᵢ}) is defined as:

$$ρ ( {e}_{i} , {o}_{k , {e}_{i}} , {prd}_{k} ) = \frac{{Σ}_{0}^{l} ( {U}_{{e}_{i}}^{{t}_{c} + o + l \times {prd}_{k}} - \frac{{Σ}_{j = {τ}_{c} + 1 + l \times {prd}_{k}}^{{t}_{c} + N - 1 + l \times {prd}_{k}} {U}_{{e}_{i}}^{{t}_{j}}}{N - 1} )}{l + 1}$$

$$l ∈ [ 0 , \frac{{prd}_{s}}{{prd}_{k}} - 1 ] , o ∈ [ 1 , N - 1 ]$$

$${o}_{k , {e}_{i}} = {arg max}_{{o}_{k , {e}_{i}}} ρ ( {e}_{i} , {o}_{k , {e}_{i}} , {prd}_{k} )$$

where t_{c} denotes a time slot for the flow fₖ to arrive at the node eᵢ.src; prdₖ denotes a period of flow fₖ; prdₛ denotes a hypercycle of the flow fₖ;

$${U}_{{e}_{i}}^{{t}_{j}}$$

denotes a slot availability of link eⱼ at time tⱼ (a remaining capacity); N denotes a number of queues for port eᵢ.src; o denotes a value range of offset; l denotes a number of times that the current flow fₖ can be sent cyclically in a hypercycle; ρ(eᵢ, o_{k,e}_{ᵢ}) denotes a load under the offset o_{k,e}_{ᵢ} in the link eᵢ;
where a higher ρ(eᵢ, o_{k,e}_{ᵢ}, prdₖ) indicates a lower time slot load corresponding to the current offset, so the offset o_{k,e}_{ᵢ} corresponding to the maximum of ρ(eᵢ, o_{k,e}_{ᵢ}, prdₖ) is taken as the offset of flow fₖ at node eᵢ.src.
S322, after the action

$${a}_{i}^{k}$$

is performed, the Environment feedback reward rₜ, the feedback reward and the next state sₜ₊₁ of the Environment is observed, and the target network generates an estimated Q value:
the features extracted from a network state sₜ and GCN are input into a main neural network Qₙₑₜ, and the network makes an action decision

$${a}_{i}^{k} a = {arg max}_{{a}_{i}^{k}} {Q}_{net} ( {s}_{t} , {a}_{i}^{k} ; θ )$$

after the action

$${a}_{i}^{k}$$

is performed, the feedback reward

$$R ( {a}_{i}^{k} )$$

is obtained and the state of sₜ is updated to sₜ₊₁, then the Q value of the action can be obtained by Q_{target}, and the specific calculation expression is

$$( where {a}_{i}^{k} ∈ 𝒜 ) :$$

$${Q}^{*} ( {s}_{t} , {a}_{i}^{k} ) = R ( {a}_{i}^{k} ) + γ {Q}_{target} ( {s}_{t + 1} , {arg max}_{{a}_{j}^{k}} {Q}_{net} ( {s}_{t + 1} , {a}_{j}^{k} ) )$$

S323, a mean square error (MSE) is used to calculate a loss;

$$Loss = {( {Q}^{*} ( {s}_{t} , {a}_{i}^{k} ; θ ) - {Q}_{net} ( {s}_{t} , {a}_{i}^{k} ; θ ) )}^{2}$$

a gradient descent method is used to update the parameters θ;
S4, a learning strategy of a GDRL model is off-line trained;
in step S4, a two-channel experience is used to replay the Q network based on the temporal difference (TD) error training GDRL model, and an experience playback mechanism is used to store the historical experience in the training process:
firstly, the TT flow is randomly generated, and the GDRL model calculates the timetable one by one for the generated TT flow, when the flow scheduling is completed, it provides rewards for all actions taken in the scheduling process.
S5, a decision is made on-line based on a trained GDRL model.

In the embodiment, the GDRL algorithm does not always generate feasible actions (that is an action that can be converted into a valid schedule). Therefore, in order to generate feasible action decisions, action control is used to omit the obviously invalid edges. In this embodiment, there are two types of edges that are considered invalid: 1) non-adjacent edges: the selected edge should be next to the last edge; 2) the edge loops that make up the edge loops will waste network resources and cause a large delay. The GDRL output selects the possibility of each edge. Then the action control marks the invalid edge. Finally, the most likely edge is selected from the valid edge. Through the above action control technology, it can make up for the errors caused by the lack of training, and the agent is more likely to make valid actions.

### Simulation Experiment

experimental environment: based on a machine with 13th Gen Intel® Core™ i7-13700KF @3.40 GHz, a software environment is based on Python 3.7 and PyTorch 1.12.0.

In this experiment, the proposed multi-cycle CSQF mechanism and GDRL algorithm are evaluated. The influence of the multi-cycle CSQF mechanism on the start-to-end delay of the flow under different network topologies is mainly studied.

In order to verify the applicability of the proposed multi-cycle CSQF mechanism, three network topologies are respectively used to compare the start-to-end delay of the flow of the multi-cycle CSQF mechanism, the three network topologies are the simplified AFDX (avionics full-duplex switched Ethernet) network used on the Airbus A380, the ladder network topology used on the train communication network, and the randomly generated network topology;
random topology: in addition to random topology, the other two topologies have specific structures. Therefore, random algorithms are used to generate random topology. The number of nodes in each topology is randomly selected between (10,20) and evenly distributed. The possibility of an edge connection between any two nodes vₘ and vₙ is 0.35. In other words, for any two nodes vₘ and vₙ, a random number between (0, 1) is generated, if the value is greater than 0.35, an edge connecting vₘ and vₙ is added.

In addition to the network topology, the TT flow is also another input to the scheduler. Both the training phase and the evaluation phase use randomly generated different flows, and the TT flow [symbol] is defined by the tuples (srcₖ, dstₖ, periodₖ, delayₖ, sizeₖ). For each random flow, the source node srcₖ and the destination node dstₖ are randomly selected from all nodes in the network. The frame length sizeₖ is an integer chosen randomly from (64,1500). The period periodₖ (in milliseconds) is chosen from the set {8,16,32}. The maximum delay delayₖ is randomly selected between 8 and 24 milliseconds, and the period is set to 500 ms.

Three agents: one for simplified AFDX topology, one for ladder topology of different sizes, and the last for random topology. Each agent is trained to converge by the related topologies and randomly generated flows mentioned above. Then use the same topology and different flows as the training to evaluate the three agents.

In the topology of different nodes, in order to illustrate the versatility of the multi-cycle CSQF mechanism, the random initial 40% nodes are used as high-speed nodes, and their cycle lengths are different from other nodes to form a multi-cycle CSQF. For example, when R=2, because the global period is set to 500 ms, the period of the high-speed node is 250 ms. In addition, in the experiment, a hypercycle scheduling is considered, and the hypercycle length is LCM(periodₖ). For convenience, the delay of link scheduling is set to the cycle length of 1 node, that is, the link delay of a high-speed port node is 250 ms, and the link delay of a low-speed port is 500 ms.

In addition, in order to verify the scheduling effectiveness of the GDRL algorithm in this present invention, the multi-branch reinforcement learning algorithm proposed by Hao Yu, Tarik Taleb, Senior Member, IEEE, and Jiawei Zhang in ‘Deep Reinforcement Learning-Based Deterministic Routing and Scheduling for Mixed-Criticality Flows’ [13] is changed into a single branch for routing selection (named DRL), meanwhile, the low load offset selection method is used to select the offset, and then compared with the GDRL algorithm proposed by the present invention in the same environment.

### Comparison of the Number of Deterministic Flow Scheduling:

In order to eliminate the randomness of the experimental results, 10 groups of network topologies are randomly generated under the corresponding network, and 1000 TT flows are generated in each group. The trained GDRL agent and DRL agent are used for testing respectively. The experimental results are shown in FIG. 4. It can be seen that the incremental scheduling flow of the two algorithms is basically the same in the case of random topology, but in special topologies such as ladder topology and AFDX topology, the DRL incremental scheduling algorithm based on GCN is obviously superior to the DRL scheduling algorithm. Implement the deterministic flow scheduling.

### Comparison of the Start-to-End Delay of Flows:

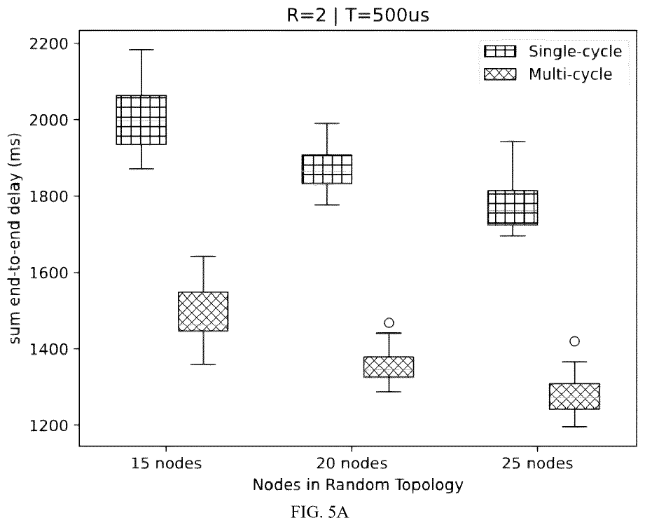

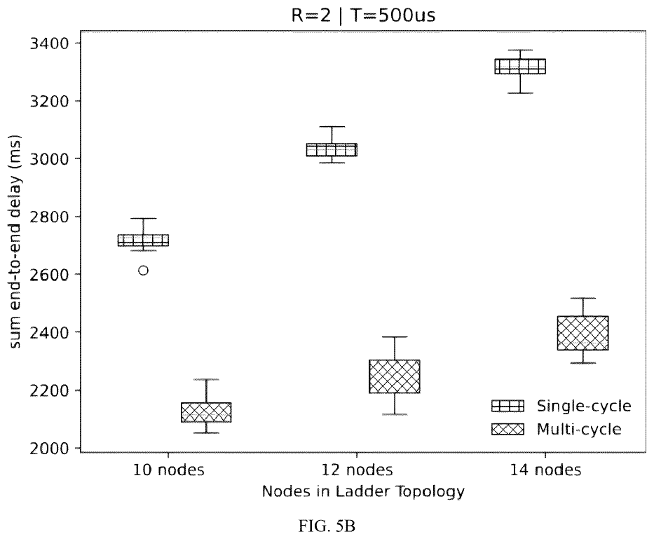

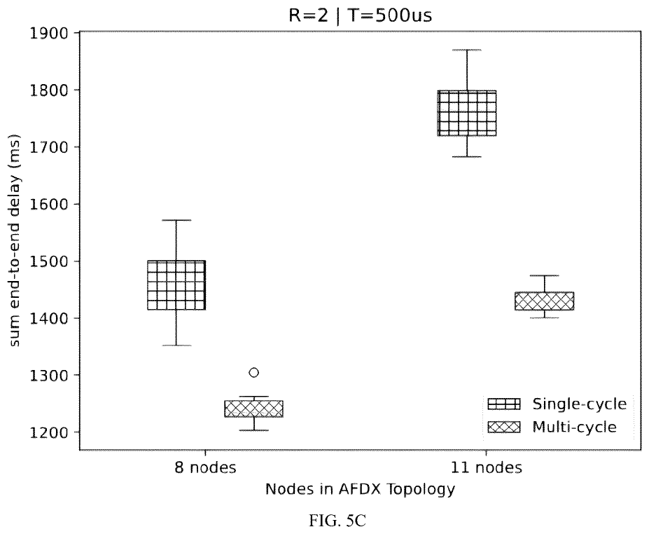

In order to verify the influence of multi-period CSQF scheduling on the start-to-end delay of the flow and reduce the randomness of the scheduling. In each topology, multiple sets of different numbers of topologies are initialized for experiments. Wherein in the random topology, 15, 20, 25 nodes are initialized, 10, 12, 14 nodes are initialized in the ladder topology, and 8, 11 nodes are initialized in the AFDX topology. The trained agents are used to conduct experiments in the same cycle CSQF and multi-cycle CSQF respectively, the number of experiments for each of the above topologies under the corresponding number of nodes is 10 times, the experimental results are shown in FIGS. 5A-5C, it can be seen that in the case of any topology, multi-cycle CSQF can significantly reduce the start-to-end delay of the flow.

Therefore, the present invention adopts the above routing and scheduling method based on multi-cycle CSQF mechanism and GDRL, and uses GCN network to extract topology information between networks, compared with the method of only using reinforcement learning, it can achieve more flow scheduling, and its performance is also stable under complex network topology, multi-cycle CSQF can reduce the start-to-end delay of the flow compared to the CSQF.

Finally, it should be noted that the above examples are merely used for describing the technical solutions of the present invention, rather than limiting the same. Although the present invention has been described in detail with reference to the preferred examples, those of ordinary skill in the art should understand that the technical solutions of the present invention may still be modified or equivalently replaced. However, these modifications or substitutions should not make the modified technical solutions deviate from the spirit and scope of the technical solutions of the present invention.

What is claimed is:

1. A routing and scheduling method based on multi-cycle cycle specified queuing and forwarding (CSQF) mechanism and graph deep reinforcement learning (GDRL), comprising the following steps:
S1, initializing a cycle index detection mechanism, a queue mapping, and a queue mapping constraint of a multi-cycle CSQF;
S2, constructing a deterministic flow routing and a low-latency scheduling (DFRLLS) model;
S3, optimizing the DFRLLS model based on the GDRL;
S4, off-line training a learning strategy of a GDRL model;
S5, making a decision on-line based on a trained GDRL model.

2. The routing and scheduling method based on the multi-cycle CSQF mechanism and the GDRL according to claim 1, wherein in the step S1, in the cycle index detection mechanism, a length of a detection cycle is set to δT_{H}, T_{H} is a detection short cycle, and the short cycle T_{H} and a long cycle T_{L} are detected simultaneously, and the short cycle T_{H} is used as a detection granularity, and an output cycle index T_{id} is output;
in the step S1, in the queue mapping, the output cycle index T_{id} is mapped to an exit queue Q_{id}, and when a ratio of the long cycle T_{L} to the short cycle T_{H} is R=2, the queue mapping is divided into the following four scenarios as shown in FIGS. 2A-2D:
a mapping from a high-speed port to the high-speed port: according to an output cycle index T_{id} of a flow received by a node and an offset is offset of the flow at the node, the flow enters a sending queue, and a mapping relationship is expressed as:
$${Q}_{id} = ( {T}_{id} + offset ) mod 3 R$$
a mapping from the high-speed port to a low-speed port: for a flow arriving in an i^{th} cycle T_{L}, since a cycle detection is based on the short cycle T_{H} as the detection granularity, the cycle detection is configured to be converted in a long cycle queue, and a mapping relationship is expressed as:
$${Q}_{id} = ( ⌊ \frac{{T}_{id}}{R} ⌋ + offset ) mod 3$$
a mapping from the low-speed port to the low-speed port: due to the detection granularity is T_{H}, the mapping from the low-speed port to the low-speed port is identical with the mapping from the high-speed port to the low-speed port, and a mapping relationship is expressed as:
$${Q}_{id} = ( ⌊ \frac{{T}_{id}}{R} ⌋ + offset ) mod 3$$
a mapping from the low-speed port to the high-speed port: the mapping from the low-speed port to the high-speed port is identical with the mapping from the high-speed port to the high-speed port, and a mapping relationship is expressed as:
$${Q}_{id} = ( {T}_{id} + offset ) mod 3 R$$
in the step S1, in the queue mapping constraint, mapping rules are divided into two types according to a cycle size of a source port and a destination port: the mapping from the high-speed port to the low-speed port and the mapping from the low-speed port to the high-speed port, a ratio of a source port cycle to a destination port cycle is denoted by
$${R}_{src , dest} = \frac{{T}_{src}}{{T}_{dest}} ;$$
when the flow is forwarded from the high-speed port to the low-speed port, that is, from a short cycle to long cycle direction, comprising an equal cycle case, a mapping rule is as follows:
$$if {R}_{src , dest} \leq 1 : {Q}_{id} = ( ⌊ \frac{{T}_{id}}{{R}_{dest , H}} ⌋ + offset ) mod {Q}_{dest}$$
wherein R_{dest,H} is a ratio of the destination port cycle to a shortest cycle; Q_{dest} is a number of queues of the destination port; offset ϵ[1, Q_{dest}−1];
when the flow is forwarded from the low-speed port to the high-speed port, that is, from a long cycle to short cycle direction, comprising the equal cycle case, a mapping rule is as follows:
$$if {R}_{src , dest} \geq 1$$
$${Q}_{id} = ( ⌊ \frac{{T}_{id}}{{R}_{src , H}} ⌋ + offset ) mod {Q}_{dest} offset ∈ [ 1 , {Q}_{est} - 1 ]$$
wherein R_{src,H} is a ratio of the source port cycle to the shortest cycle, Q_{dest} is the number of the queues of the destination port; offset ϵ[1, Q_{dest}−1].

3. The routing and scheduling method based on the multi-cycle CSQF mechanism and the GDRL according to claim 2, wherein in the step S1, the multi-cycle CSQF is extended under the following extension conditions:
if a switch supports m different CSQF cycles T₁, T₂, . . . , Tₘ, a shortest cycle Tₘᵢₙ=T₁, T₂, . . . , Tₘ, a longest cycle Tₘₐₓ=max(T₁, T₂, . . . , Tₘ), while satisfying that a ratio
$${R}_{i , j} = \frac{{T}_{i}}{{T}_{j}}$$
between two cycles is an integer;
for multi-cycle CSQF routers meeting the extension conditions, the shortest cycle Tₘᵢₙ is the detection granularity, the detection cycle is 3Tₘₐₓ, and an output T_{id} range of a packet arrival in the detection cycle is within [0,3R_{max,min}−1].

4. The routing and scheduling method based on the multi-cycle CSQF mechanism and the GDRL according to claim 1, wherein the step S2 comprises the following steps:
S21, constructing a network flow model:
a network topology is abstracted as a directed graph, and the network topology is denoted as G and G={V, E}, wherein V is a set of DN routing nodes, E is a set of r edges connecting two network nodes (E ⊂V×V), and a full-duplex physical link between node Vₐ ϵV and node V_{b} ϵV contains two directed edges, and the two directed edges are denoted as [Vₐ, V_{b}]ϵE and [V_{b}, Vₐ]ϵE, respectively, a attribute of each link eᵢ=[Vₐ, V_{b}] is denoted by a quadruple:
$$< {e}_{i} . S , {e}_{i} . T , {e}_{i} . C , {e}_{i} . D >$$
wherein eᵢ.S is a link rate; eᵢ.T is a cycle of a multi-cycle CSQF on the link; eᵢ.C is a valid time slot capacity; eᵢ.D is a delay of the link, wherein the delay comprises a propagation delay, a transmission delay, and a processing delay;
S22, constructing the DFRLLS model:
S221, for a flow fₖ to be scheduled, a controller determines that a link sequence of an only feasible scheduling link P is (e₁, e₂, . . . , eₘ), wherein a link eᵢ starts from a source node srcₖ, a link eₘ ends at a destination node dstₖ, and eᵢ and eᵢ₊₁ are adjacent links, and the following constraints are adopted:
$${e}_{1} . src = {src}_{k}$$
$${e}_{n} . d st = {dst}_{k}$$
$${e}_{i} . dst = {e}_{i + 1} . src$$
wherein e₁.src denotes a starting point of the link e₁; srcₖ denotes a starting point of a flow; eₙ.dst denotes an ending point of a link eᵢ; dstₖ denotes a destination node; eᵢ.dst denotes an ending point of link eᵢ; eᵢ₊₁.src denotes a starting point of link eᵢ₊₁;
S222, defining an integer variable o_{k,e}_{ᵢ} to denote an offset of all packets of the flow fₖ in each link eᵢ;
based on different cycle lengths of different links, it is assumed that a first packet of the flow fₖ arrives at the source node srcₖ at
$${t}_{1}^{k} ,$$
which denotes that the flow fₖ is emitted from the source node srcₖ in a cycle t₁+o_{k,e}_{ᵢ}×eᵢ.T, and arrives a next node in a cycle t₁+o_{k,e}_{ᵢ}×e_{g}.T+eᵢ.D, which is denoted by
$${t}_{2}^{k} ,$$
so that a cycle of the flow fₖ is denoted by an integer sequence
$$( {t}_{1}^{k} , {t}_{2}^{k} , ⋯ , {t}_{n}^{k} ) ,$$
wherein
$${t}_{n}^{k} ∈ {Z}^{+}$$
is a cyclic index of the first packet arriving at a corresponding node eᵢ.src, and then an arrival cycle of remaining packets is calculated by
$$l \times {period}_{k}$$
$$l ∈ \{ 0 , 1 , ⋯ , n \} ;$$
S223, expressing a scheduling Sₖ of the flow fₖ from the source node srcₖ to the destination node dstₖ as
$$\{ ( {e}_{1}^{k} , {t}_{1}^{k} , {o}_{k , {e}_{1}} ) , ( {e}_{2}^{k} , {t}_{2}^{k} , {o}_{k , {e}_{2}} ) , … , ( {e}_{n}^{k} , {t}_{n}^{k} , {o}_{k , {e}_{n}} ) \} ;$$
S224, judging whether Sₖ is valid for the flow fₖ by using the following conditions:
start-to-end delay constraint of the flow: a start-to-end delay of the all packets of the flow fₖ does not allow to exceed a start-to-end delay limit delayₖ of a maximum flow:
$${t}_{n}^{k} - {t}_{1}^{k} \leq {delay}_{k}$$
cycle capacity constraint: if a packet of the flow fₖ is determined to be transmitted at a link eᵢ of a cycle t, denoted as
$${χ}_{k , {e}_{i}}^{t} ,$$
a queue capacity of the cycle t is shared among scheduled flows, so a traffic load of edge Ei within the cycle t is within an upper limit of the queue capacity:
$${\sum }_{{f}_{k} ∈ F} {χ}_{k , {e}_{i}}^{t} \times {size}_{k} \leq {e}_{i \cdot } C$$
wherein F denotes a set of all flows fₖ; eᵢ.C denotes a capacity of the link eᵢ in the cycle t;
S225, expressing a flow scheduling problem as: in a case of a given network topology and deterministic networks (DN) flow, find a valid scheduling for all flows, so that all time-triggered (TT) flows are scheduled, and a definition is as follows:
$$max {\sum }_{1}^{n} Scheduled ( {f}_{i} )$$
wherein n denotes a total number of the scheduled flows; Scheduled(fᵢ) denotes a processing function of the flow, when the flow is scheduled successfully, it is Scheduled(fᵢ)=1, otherwise Scheduled(fᵢ) is 0.

5. The routing and scheduling method based on the multi-cycle CSQF mechanism and the GDRL according to claim 4, wherein in the step S3, a construction of the DFRLLS model reinforcement learning model is modeled, and a Markov decision process (MDP) model is constructed, the MDP model composes state space [symbol] , action space [symbol] , and reward space [symbol] ;
wherein the state space [symbol] is designed as follows: a system state sₜ is set to denote all link information of an entire network, a deep reinforcement learning (DRL) agent is utilized to observe and use the system state sₜ to generate a schedule Sₖ for the flow fₖ, and then extract network characteristics from the following three aspects to denote the system state sₜ: topology information, flow information, and network cycle load information;
a reachability matrix M of |E|×|E| is designed, wherein |E| is a number of edges in a whole network topology; the reachability matrix M indicates whether a path exists between the link eᵢ and a link eⱼ, wherein one node is comprised;
the action space [symbol] is designed as follows: the GDRL divides a path of TT flow into a set of adjacent edges, scheduling of the TT flow
$$\begin{matrix}{S}_{k} = \{ {a}_{1}^{k} , {a}_{2}^{k} , … , {a}_{n}^{k} \} \\ = \{ ( {e}_{1}^{k} , {t}_{1}^{k} , {o}_{k , {e}_{1}} ) , ( {e}_{2}^{k} , {t}_{2}^{k} , {o}_{k , {e}_{2}} ) , … , ( {e}_{n}^{k} , {t}_{n}^{k} , {o}_{k , {e}_{n}} ) \} ,\end{matrix}$$
the scheduling Sₖ consists of a series of sub-actions
$${a}_{1}^{k} , {a}_{2}^{k} , … , {a}_{n}^{k} ,$$
a sub-action
$${a}_{i}^{k}$$
is defined by a tuple
$$( {e}_{i}^{k} , {t}_{i}^{k} , {o}_{k , {e}_{i}} ) , {e}_{i}^{k}$$
denotes an edge that the flow needs to pass through,
$${t}_{i}^{k}$$
denotes a time that the flow arrives a source node of the link eᵢ, o_{k,e}_{ᵢ} denotes an offset of the flow in a link
$${e}_{i} . src , {t}_{i}^{k} + {o}_{k , {e}_{i}}$$
is a time sent out from the link eᵢ.src;
reward space [symbol] : when making an action decision aₜ, the reward space [symbol] is calculated by Environment of the GDRL model, and a DRL model and a graph convolutional network (GCN) of the GDRL model are trained with the reward space [symbol] to update parameters θ of the GDRL model, and through the following formula to determine whether the flow fₖ is successfully scheduled:
$${H}_{k} = \{ \begin{matrix}1 , & if the flow {f}_{k} is scheduled successfully \\ - 1 , & if the flow {f}_{k} is scheduled unsuccessfully\end{matrix}$$
moreover, scheduling of each flow is composed of a series of sub-actions
$${a}_{i}^{k} = ( {e}_{i}^{k} , {t}_{i}^{k} , {o}_{k , {e}_{i}} ) ,$$
and the reward space [symbol] of whole sub-actions is composed of two parts: a first part is a degree value corresponding to the offset of the flow fₖ on the link eᵢ, wherein the offset is determined by an offset allocation method, in the offset allocation method, the degree value is given for an offset cycle of a node, the higher the degree value, the lower a load in the offset cycle, and meanwhile a reward of the sub-action is given by the degree value; rewards
$$R ( {a}_{i}^{k} )$$
for a first part sub-action are as follows:
$$R ( {a}_{i}^{k} ) = ρ ( {e}_{i} , {o}_{k , {e}_{i}} )$$
wherein ρ(eᵢ, o_{k,e}_{ᵢ}) denotes an availability of a flow fᵢ in a link eᵢ source node offset o_{k,e}_{ᵢ} cycle;
a second part takes effect when the sub-action is part of complete scheduling of the flow fₖ or not, that is, the reward for successful scheduling of the flow will only take effect when the sub-action
$${a}_{i}^{k}$$
a is a last edge of the valid scheduling, after selecting a last action
$${a}_{n}^{k}$$
of a valid route, check whether the flow is scheduled successfully, and then add additional rewards to the second part in an attenuated manner to update a sub-action
$$R ( {a}_{1}^{k} ) , R ( {a}_{2}^{k} ) , … , R ( {a}_{n}^{k} ) ;$$
a reward
$$\hat{R} ( {a}_{i}^{k} )$$
for the second part sub-action is as follows:
$$\hat{R} ( {a}_{i}^{k} ) = R ( {a}_{i}^{k} ) + α {H}_{k} \times \frac{i}{n} ∀ i ∈ \{ 1 , ⋯ , n \}$$
where α denotes an attenuation factor, and updates the reward of the sub-action by increasing an additional reward of the second part in an attenuated manner.

6. The routing and scheduling method based on the multi-cycle CSQF mechanism and the GDRL according to claim 5, wherein the step S3 comprises the following steps:
S31, setting an optimization objective to maximize a number of the scheduled flows under a given number of flows, and obtaining an optimal DFRLLS scheduling strategy:
$${max}_{π} 𝔼 [ {\sum }_{{f}_{k} ∈ ℱ} {{\sum }^{n}}_{i = 1} {β}^{i} R ( {a}_{i}^{k} ) ]$$
wherein π* denotes to maximize a long-term return of the flows mapped to a network;
$$R ( {a}_{i}^{k} )$$
denotes a reshaping reward under strategy π; a discount factor β denotes a ratio of a current reward to a subsequent reward;
S32, carrying out an edge selection based on a GDRL network model, transforming an optimization problem of the DFRLLS model into an optimization problem of maximizing expected future discounted returns:
the GCN is used to extract a spatial dependence of the network topology, and extracted features are fused with link features, the extracted features are input into a main network and a Q value is output.

7. The routing and scheduling method based on the multi-cycle CSQF mechanism and the GDRL according to claim 6, wherein the step S32 comprises the following steps:
S321, using a three-layer GCN as a feature extractor to extract a spatial correlation of the network topology:
Environment inputs a link state sₜ and the reachability matrix M into the main network, the main network uses the GCN to process each link by aggregating features of adjacent links of each link, aggregated features and the link state sₜ are input into a function approximator together to generate a next hop for each flow, and an offset is assigned to this hop;
S322, after performing the sub-action
$${a}_{i}^{k} ,$$
the Environment feedback reward rₜ, observing a feedback reward and a next state sₜ₊₁ of the Environment, and a target network generates an estimated Q value:
features extracted from a network state sₜ and the GCN are input into a main neural network Qₙₑₜ, and the main neural network Qₙₑₜ makes an action decision
$$\begin{matrix}{a}_{i}^{k} \\ a = {arg max}_{{a}_{i}^{k}} {Q}_{net} ( {s}_{t} , {a}_{i}^{k} ; θ )\end{matrix}$$
after the sub-action
$${a}_{i}^{k}$$
is performed, the feedback reward
$$R ( {a}_{i}^{k} )$$
is obtained and the state of sₜ is updated to sₜ₊₁, then a Q value of the sub-action
$${a}_{i}^{k}$$
is obtained by Q_{target}, and a specific calculation expression is
$$( wherein {a}_{i}^{k} ∈ 𝒜 ) : {Q}^{*} ( {s}_{t} , {a}_{i}^{k} ) = R ( {a}_{i}^{k} ) + γ {Q}_{target} ( {s}_{t + 1} , {arg max}_{{a}_{j}^{k}} {Q}_{net} ( {s}_{t + 1} , {a}_{j}^{k} ) )$$
a mean square error (MSE) is used to calculate a loss;
$$Loss = {( {Q}^{*} ( {s}_{t} , {a}_{i}^{k} ; θ ) - {Q}_{net} ( {s}_{t} , {a}_{i}^{k} ; θ ) )}^{2}$$
a gradient descent method is used to update the parameters θ.

8. The routing and scheduling method based on the multi-cycle CSQF mechanism and the GDRL according to claim 7, wherein in the step S321, the offset is selected based on a number of receiving node queues:
a difference between a load of each receiving queue and an average load of all receiving queues is made, and the average load sent by the flow fₖ in a hypercycle is considered, and ρ(eᵢ, o_{k,e}_{ᵢ}) is defined as:
$$\begin{matrix}ρ ( {e}_{i} , {o}_{k , {e}_{i} , {prd}_{k}} ) = \frac{{\sum }_{0}^{l} ( {U}_{{e}_{i}}^{{t}_{c} + o + l \times {prd}_{k}} - \frac{{\sum }_{j = {t}_{c} + 1 + l \times {prd}_{k}}^{{t}_{c} + N - 1 + l \times {prd}_{k}} {U}_{{e}_{i}}^{{t}_{j}}}{N - 1}}{l + 1} \\ l ∈ [ 0 , \frac{{prd}_{s}}{{prd}_{k}} - 1 ] , o ∈ [ 1 , N - 1 ] \\ {o}_{k , {e}_{i}} = {arg max}_{{o}_{k , {e}_{i}}} ρ ( {e}_{i} , {o}_{k , {e}_{i}} , {prd}_{k} )\end{matrix}$$
wherein t_{c} denotes a time slot for the flow fₖ to arrive the node eᵢ.src; prdₖ denotes a period of the flow fₖ; prdₛ denotes a hypercycle of the flow fₖ;
$${U}_{{e}_{i}}^{{t}_{j}}$$
denotes a slot availability of the link eᵢ at time tⱼ (a remaining capacity); N denotes a number of queues for port eᵢ.src; o denotes a value range of the offset; l denotes a number of times that a current flow fₖ is sent cyclically in a hypercycle; ρ(eᵢ, o_{k,e}_{ᵢ}) denotes a load under the offset o_{k,e}_{ᵢ} in the link eᵢ;
wherein a higher ρ(eᵢ, o_{k,e}_{ᵢ}, prdₖ) indicates a lower time slot load corresponding to a current offset, so the offset o_{k,e}_{ᵢ} corresponding to a maximum of ρ(eᵢ, o_{k,e}_{ᵢ}, prdₖ) is taken as the offset of the flow fₖ at the node eᵢ.src.

9. The routing and scheduling method based on the multi-cycle CSQF mechanism and the GDRL according to claim 1, wherein in the step S4, a two-channel experience is used to replay a Q network based on a temporal difference (TD) error training GDRL model, and an experience playback mechanism is used to store a historical experience in a training process:
firstly, the TT flow is randomly generated, and the GDRL model calculates the timetable one by one for a generated TT flow, when flow scheduling is completed, it provides rewards for all actions taken in a scheduling process.

10. The routing and scheduling method based on multi-cycle CSQF mechanism and GDRL according to claim 4, wherein in the step S225, the DN flow is defined as a periodic unicast flow from the source node to the destination node, a set of DN flows is denoted as [symbol] , and the DN flow fₖ ϵ [symbol] is defined as a tuple (srcₖ, dstₖ, periodₖ, delayₖ, sizeₖ), wherein srcₖ and dstₖ denote the source node and destination node of the flow fₖ, respectively; periodₖ denotes a period of the flow fₖ, that is, a data packet sent by the source node in each periodₖ cycle; sizeₖ denotes a size of the flow fₖ; delayₖ denotes a delay composition from the start-to-end of the maximum flow;
since the flow has different periods periodₖ, a total scheduling cycle is defined and called a hypercycle, in each hypercycle, all network behaviors are identical, and hypercycle periods of all flows are calculated as a least common multiple of all flow periods.
